(19) United States
(12) Patent Application Publication
(10) Pub. No.: US 2005/0115498 A1
(43) Pub. Date: Jun. 2, 2005

(54) Reflector for UV curing systems

(76) Inventors: Michael W. Ingram, San Diego, CA (US); Bernard J. Eastlund, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/948,091

(22) Filed: Sep. 23, 2004

Related U.S. Application Data
(60) Provisional application No. 60/505,681, filed on Sep. 23, 2003.

(51) Int. Cl. B05B 5/00

(52) U.S. Cl. 118/642; 427/595

(57) ABSTRACT

Apparatus providing reflectors for ultraviolet (UV) curing systems are described, wherein a diffuse reflecting material is used and a total flux reflected from a surface onto an exposed surface is increased. A cooling system may be used to maintain a temperature of the diffuse reflecting material below a softening point or maximum operating temperature. The reflector may take on many forms, including a parabolic or circular shape, and the UV source may be a high intensity UV light source.

### CROSS REFERENCE OF RELATED APPLICATIONS

This application claims priority under 35 U.S.C. 119(e) to U.S. Provisional Application No. 60/505,681 entitled IMPROVED REFLECTOR FOR MICROWAVE LAMPS, filed on Sep. 23, 2003, which is hereby incorporated by reference in its entirety.

### BACKGROUND OF THE INVENTION

1. Field of the Invention

This invention generally relates to an ultraviolet (UV) curing system. Specifically, embodiments are described that relate to UV curing of inks and coatings.

2. Description of the Related Art

UV lamps having reflectors that direct UV light towards a surface may be used to cure inks and coatings. These reflectors are typically specular reflectors with shapes that are elliptical and focusing or parabolic and defocusing. The elliptical reflectors have a high intensity UV source at one focus of an ellipse with the emitted UV rays focused at the second focus on the ellipse.

These reflectors are also generally made of an anodized aluminum material or a dichroic multiple thin film material, with each material having its own reflective properties. The anodized aluminum reflectors are specular reflectors with a reflectivity of about 70% at 250 nm and about 20% at 200 nm. These reflectors do not transmit the UV spectrum of a lamp to an exposed surface without changing the spectrum of UV radiation. As a result, the entire spectrum of UV radiation is not transmitted and applied to the surface of exposure.

In comparison, the dichroic reflectors are specular reflectors with a reflectivity of about 92 to 94% in a specific wavelength, for example 220 to 260 nm, but have a comparatively poor reflectivity outside those bands. These reflectors are composed of multiple layers of oxides deposited on metal or glass surfaces.

An example of an elliptical specular reflector is made by Fusion UV Systems, Inc. for use in microwave lamps. The Fusion UV reflector has a reflectivity that ranges approximately from 20% at 200 nm to 70% at 240-270 nm and 86% at visible wavelengths. It also has an elliptical shape with a bulb at the first focus of the ellipse. The second focus of the ellipse is a few inches outside of the lamp housing, though in some applications it is intentionally de-focused to create a more uniform flux outside the housing.

The Fusion UV elliptical specular reflector is made of Alzak, an anodized aluminum material. The reflector forms a portion of a microwave cavity that couples microwave energy into a high intensity UV bulb lamp, which is linear and electrodeless. The light exits the cavity through a metallic screen, usually made of fine tungsten wire so it contains the microwaves and allows light to pass through with about 5 to 10% absorption due to the wires. The reflector incorporates slots for coupling the microwave energy from the magnetron into the lamp cavity formed by the reflector and metallic screen. Other holes are placed in the reflector to allow cooling air to flow through the reflector, across the bulb and out of the cavity.

In the case of the Fusion UV F300S lamp, about 690 Watts is radiated as light and 181 watts is radiated in UV between 200 and 300 nm. About 30% exits the reflector directly, about 5% is lost through the cooling holes and slots in the reflector, and about 65% is incident on the Alzak reflector surface which reflects at 70%. Thus, about 54 watts exit the lamp directly and about 82 watts are focused by the reflector for a total available UV power of 136 watts. The need therefore exists for an improved reflector for UV curing systems that is more efficient.

### SUMMARY OF THE INVENTION

The inventions described herein provide for UV curing with an increase of the total flux of UV delivered to a surface. For example, a high intensity UV lamp-reflector combination is described wherein the total flux of light is increased over present methods while maintaining a reflectivity greater than 95% over the entire UV wavelength region between 200 nm and 400 nm.

In one embodiment of the improved reflector for UV curing, a diffuse material is used to line the inside of a an elliptical specular reflector, thereby increasing the total UV flux from the reflector towards the surface to be irradiated and transmitting the UV spectrum with high fidelity. Similarly, in a second embodiment a reflector for a high intensity arc lamp is lined with a diffuse reflecting material and in a third embodiment a circular shaped reflector is lined with a diffuse reflecting material. A cooling system may also be provided where necessary so the temperature of the diffuse reflecting material does not exceed a softening point or a maximum operating temperature.

These and other objects and features of the present invention will become more fully apparent from the following description and appended claims taken in conjunction with the following drawings, where like reference numbers indicate identical or functionally similar elements.

### BRIEF DESCRIPTION OF THE DRAWINGS

FIG. 1 is a diagram of an elliptical reflector.

FIG. 2 is an illustration of light reflecting from a diffuse reflector.

FIG. 3A is a diagram of a high intensity arc lamp used for UV curing.

FIG. 3B is a diagram of a diffuse reflector and fan.

FIG. 4 is a diagram of a diffuse reflector and fan illustrating peak flux.

FIG. 5 is a diagram of a UV curing system.

### DETAILED DESCRIPTION OF THE PREFERRED EMBODIMENT

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the invention herein described.

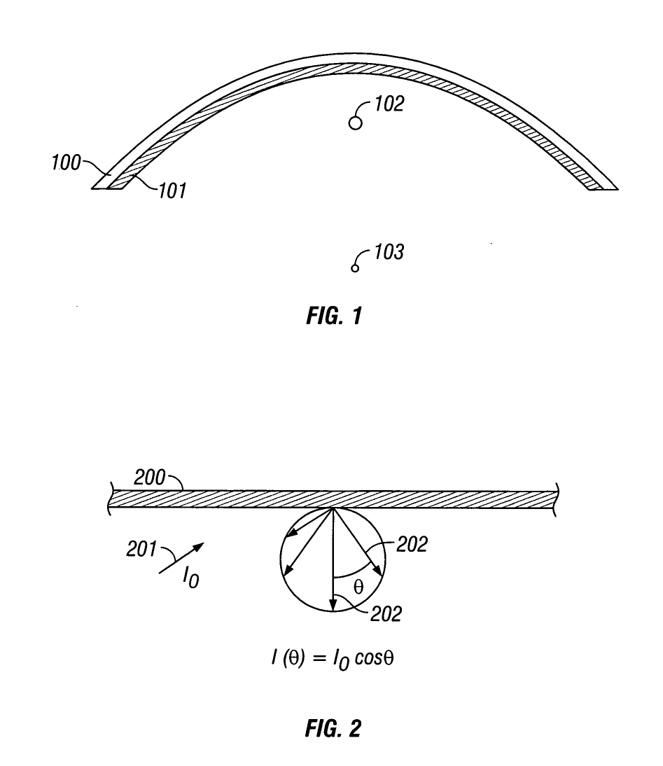

The first embodiment is to line a shaped surface of metal, glass, or other structural material with a diffuse reflector material, such as Teflon or any other suitable diffuse reflective material. As illustrated in FIG. 1, a diffuse reflector comprises an elliptical surface 100 that is lined with a diffuse reflecting material 101. Such a reflector is also referred to as a Lambertian reflector.

A Lambertian or diffuse reflector is a reflecting surface which reflects incident light in all directions regardless of the angle it is incident on the diffuse reflector. A Lambertian surface is defined as a surface from which the energy emitted in any direction is substantially proportional to the cosine of the angle which that direction makes with the normal to the surface. As illustrated in FIG. 2, an incident ray of light 201 incident on a diffuse reflecting surface 200 emits rays 202 with a substantially cosine distribution with respect to the reflecting surface 200 in a substantially cosine dependence on theta, where theta is the angle between the perpendicular to the surface and the direction of emission. For example, if a diffuse reflector comprises a portion of a panel in a reflecting chamber, incident light will be scattered from the panel in all directions regardless of the shape of the diffuse reflector and the relationship of other panels in the reflecting chamber. With the diffuse reflector, the fluence within a reflective chamber may be substantially uniform regardless of the chamber geometry, UV source geometry, and UV source location within the chamber. Thus, a substantially uniform illumination inside a reflective chamber is possible regardless of the geometric shape of the chamber and the location of the emitter within the chamber.

If the elliptical reflector 100 of FIG. 1 were a specular reflector, such as the Fusion UV elliptical specular reflector, then high intensity UV source located at one focus 102 of the ellipse and would have its emitted rays focused at the second focus 103 of the ellipse. In contrast, if the Fusion reflector was lined with a diffuse material, thereby creating a diffuse Lambertian reflector, the same ellipse would not focus the rays on the second focus of the ellipse, but would increase the total UV flux from the reflector towards the surface to be irradiated and would transmit the UV spectrum with high fidelity, i.e. the spectra striking the surface to be irradiated would be close to the same as that emitted by the high intensity UV source.

Accordingly, one embodiment of the invention is to line the existing reflector of a lamp (such as the F300S Fusion lamp) with a diffuse material. Different types of diffuse material may be used to create a Lambertian or diffuse reflector. For example, diffuse reflecting Teflon ePTFE material (trade name DRP) from the W. L. Gore company has a reflectivity above 95% from 200 nm to 400 nm, a diffuse reflecting Teflon PTFE material (trade name Spectralon) from Labsphere, Inc. has a reflectivity of greater than 92% from 200 nm to 400 nm, and a Teflon material called Zenith from Sphere Optics has a reflectivity greater than 94%. Teflon materials are not the only suitable diffuse reflective material. Any material providing the desired reflective properties may be used.

In the case of lining a surface that forms a surface for coupling microwaves into a microwave cavity containing an electrodeless lamps, wherein the surface has slots used for coupling microwaves from the microwave source to the lamp, the lining of diffuse material should be sufficiently recessed from the slots to be outside the high electric field region created by the microwaves passing through the slots. If the lining is not recessed, arcing may occur in the slot due to the high electric fields that exist in the slot. This arcing may spoil the coupling between the magnetron and the lamp. About ¼″ clearance is sufficient in the case of the F300S Fusion lamp. Other appropriate clearance values may be obtained depending on the configuration of the reflecting system. This clearance should be kept as small as possible because it exposes the lower reflectivity backing material.

The lining of diffuse material should also have an adequate cooling system to ensure that the temperature of the lining material does not exceed its softening point or maximum operating temperature. For example, holes within the lining material may allow cooling air to enter the microwave cavity. Cooling air for the electrodeless lamp may then flow over and around the lining, which is adhered to the reflector, thereby helping to maintain the temperature of the lining below its softening point or maximum operating temperature.

As an example of this embodiment, a F300S Fusion lamp reflector was lined with DRP from the W. L. Gore Company and the output measured and compared to the output with an unlined reflector. Calorimeter measurements were taken on axis at 9.25″ and 21.75″ away from the mesh. A 295 nm cutoff filter was used to measure the far UV content. The temperature of the DRP was also measured to be 73 C., well below its limit of about 300 C.

The data from the above described example is shown in Table 1. The lamp was operated for about 16 hours and no degradation in total optical output power or far UV output power was observed.

TABLE 1

| Dis- | | | Output with | Output | % of |
|---|---|---|---|---|---|
| tance | | Total optical | 295 cutoff | <295 | output |
| from | | output flux | filter | nm | <295 nm |
| mesh | Reflector | (W/cm²) | (W/cm²) | (W/cm²) | (W/cm²) |
| 9.25″ | Standard | 0.392 | 0.225 | 0.167 | 42.6% |
| | DRP lined | 0.489 | 0.281 | 0.208 | 42.6% |
| | Increase | 25% | | | |
| | due to | | | | |
| | lining | | | | |
| 21.75″ | Standard | 0.066 | 0.039 | 0.027 | 40.9% |
| | DRP lined | 0.100 | 0.061 | 0.039 | 39.0% |

| | |
|---|---|
| Increase | 52% |
| due to | |
| lining | |

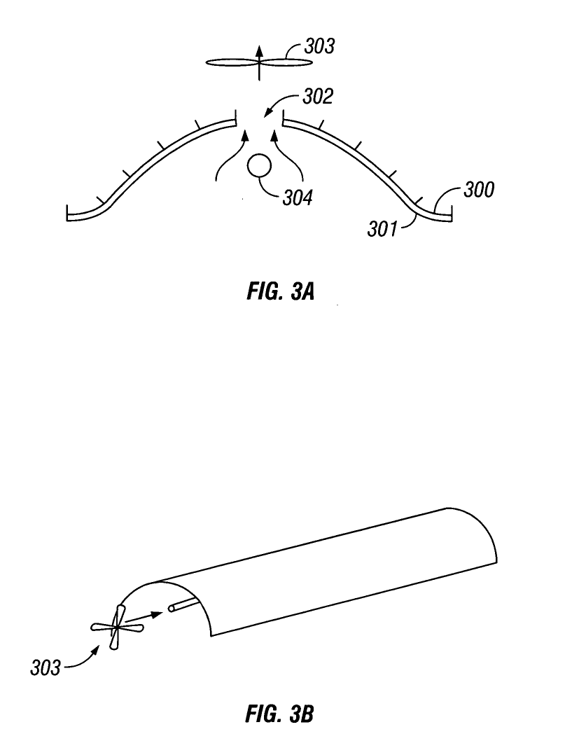

A second embodiment comprises a high intensity arc lamp with a reflector lined with a diffuse material, as depicted in FIG. 3A. High intensity arc lamps are commonly used for UV curing. A typical high intensity arc lamp reflector 300 is elliptical with the lamp 304 mounted at the focus of the ellipse. The typical reflector also has a longitudinal slot 302 along its apex for cooling of the lamp by convection through the slot. These reflectors are also commonly lined with a specular reflector made of Alzak.

Instead of using the specular reflector material, the second embodiment lines the reflector with a diffuse reflecting material 301 without blocking the cooling opening. In this embodiment, the airflow over the surfaces 300 or the 301 should be increased to prevent overheating of the lining material. For example, a Teflon liner may be subject to overheating because the typical lamp has power levels of 200-600 watts per linear inch. In such cases, as illustrated in FIG. 3B, a fan 303 may be located over the slot 302 to increase the rate of airflow away from the lamp. This fan may blow or suck air from one end of the reflector. The air flow should preferably be sufficient to maintain the temperature of the diffuse reflecting material below a maximum operating temperature.

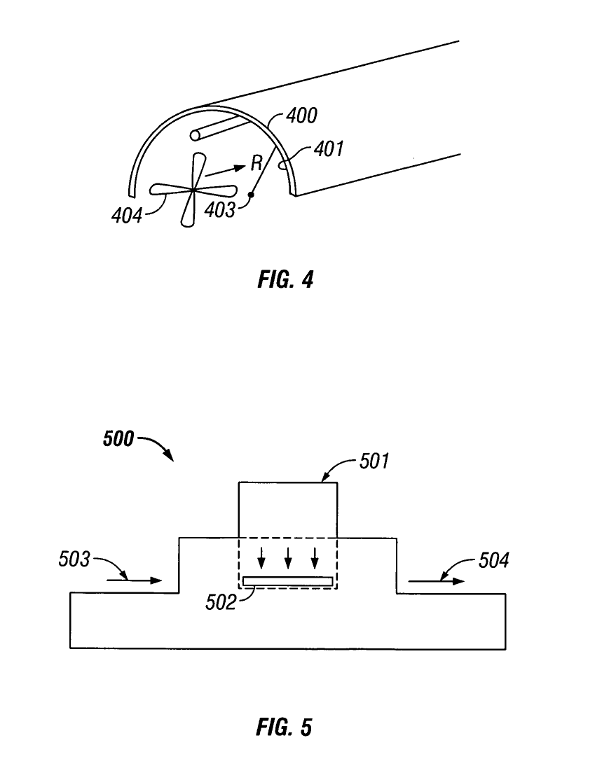

In a third embodiment, a diffuse reflecting reflector with a circular shape with radius of curvature R will create a peak flux on the center of a circle 403. This is because the highest emission direction is perpendicular to a surface. Because specular reflection has been used in conventional reflectors, which necessitates elliptical or parabolic reflector shapes, circular lamp reflector configurations have not previously been considered. Such a reflecting surface 401 is shown in FIG. 4. The support surface of the reflector 400 is lined with a diffuse reflecting material 401. The peak flux would be located at the center of the circle of revolution 403. The lamp may be located anywhere proximate to the surface 401 and a cooling fan 404 may also be used to move air by the lined surface to ensure its temperature is maintained below the lining's softening point. It will be appreciated that either spherical or cylindrical reflectors may be utilized as each forms a surface defining a substantially circular arc.

In a fourth embodiment, as depicted in FIG. 5, a UV light source 501 is advantageously incorporated into a curing system 500. In this system, the UV light source 501 comprises a shaped reflector with at least of portion of the reflector lined with a diffuse reflecting material. In this configuration, at least a portion of UV light emitted from the UV light source reflects off of the diffuse reflecting material thereby exposing an item 502 to UV. The curing chamber also comprises an input area 503 for uncured items to enter the system and an output area 504 for cured items to exit. This curing system may also incorporate a cooling system, such as a cooling fan, to move air by the diffuse lining material to ensure its temperature is maintained below its softening point.

Specific parts, shapes, materials, functions and modules have been set forth, herein. However, a skilled technologist will realize that there are many ways to fabricate the system of the present invention, and that there are many parts, components, modules or functions that may be substituted for those listed above. While the above detailed description has shown, described, and pointed out the fundamental novel features of the invention as applied to various embodiments, it will be understood that various omissions and substitutions and changes in the form and details of the components illustrated may be made by those skilled in the art, without departing from the spirit or essential characteristics of the invention.

1. An apparatus for applying ultraviolet (UV) light to a curing surface comprising:
a shaped reflector having at least a portion of an internal surface thereof lined with or constructed from with a layer of diffuse reflecting material with said diffuse reflecting material facing an opening in said reflector configured for exposing said curing surface to UV; and
a UV emitting light source located with respect to the shaped reflector such that a portion of the UV light is incident on the diffuse reflecting material.

2. The apparatus of claim 1, wherein the shaped reflector is a microwave lamp reflector forming part of a microwave cavity used to couple microwaves into an electrodeless lamp.

3. The apparatus of claim 2, wherein the diffuse reflecting material is attached to the surface of the microwave lamp reflector with adhesive.

4. The apparatus of claim 1, further comprising a cooling system that maintains the temperature of said diffuse reflecting material at or below a maximum operating temperature.

5. The apparatus of claim 1, wherein the shaped reflector comprises cooling fins and a slot for carrying away convective heat.

6. The apparatus of claim 2, wherein the microwave lamp reflector comprises openings wherein a temperature of the diffuse reflecting material is kept below a softening point by an air flow through said openings.

7. The apparatus of claim 2, wherein the microwave lamp reflector comprises slots used to couple microwaves through the shaped surface into the microwave cavity and electrodeless lamp, and wherein the diffuse reflecting material is recessed from the edges of said slots.

8. The apparatus of claim 1, wherein the shaped reflector is a high intensity arc lamp reflector.

9. The apparatus of claim 1, wherein the shaped reflector is substantially elliptical in cross section.

10. The apparatus of claim 1, wherein the shaped reflector is substantially parabolic in cross section.

11. The apparatus of claim 1, wherein a slot is located in the reflector and a fan is used to force air to flow over the diffuse reflector material to maintain the temperature of said diffuse reflecting material below the maximum operating temperature.

12. The apparatus of claim 1 wherein the shaped reflector has a cross section that forms a substantially circular arc.

13. The apparatus of claim 12, wherein a fan is used to force air to flow over the diffuse reflector material to maintain the temperature of said diffuse reflecting material below the maximum operating temperature.

14. An ultraviolet (UV) curing system comprising:
a curing chamber having an input for uncured items and an output for cured items; and
a source of UV radiation within said curing chamber, wherein said source of UV radiation comprises a shaped reflector lined on at least a portion of an internal surface with a layer of diffuse reflecting material, wherein said reflector and said diffuse reflecting material are configured for exposing an item to UV.

15. The system of claim 14, wherein the shaped reflector is a microwave lamp reflector forming part of a microwave cavity used to couple microwaves into an electrodeless lamp.

16. The system of claim 14, further comprising a cooling system that maintains a temperature of said diffuse reflecting material at or below a maximum operating temperature.

17. The apparatus of claim 14, wherein the shaped reflector is substantially elliptical in cross section.

18. The apparatus of claim 14, wherein the shaped reflector is substantially parabolic in cross section.

19. The apparatus of claim 14, wherein the shaped reflector is a high intensity arc lamp reflector.

20. The apparatus of claim 19, wherein the shaped reflector is substantially elliptical in cross section.

21. The apparatus of claim 19, wherein the shaped reflector is substantially parabolic in cross section.

22. The apparatus of claim 14, wherein a slot is located in the reflector and a fan is used to force air to flow over the diffuse reflector material to maintain the temperature of said diffuse reflecting material below the maximum operating temperature.

23. The apparatus of claim 14 wherein the shaped reflector forms a substantially circular arc.

24. The apparatus of claim 23, wherein a fan is used to force air to flow over the diffuse reflector material to maintain the temperature of said diffuse reflecting material below the maximum operating temperature.

25. An apparatus for reflecting ultraviolet (UV) light from a diffuse reflecting surface comprising:
a shaped surface with a concave circular contour configured for facing a surface to be exposed to UV illumination;
a lining of diffuse reflecting material over at least a portion of said shaped surface; and
a UV emitting light source located with respect to the shaped surface such that a portion of the UV light emitted from the light source is incident on the diffuse reflecting material.

26. The apparatus of claim 25, further comprising a cooling system that maintains a temperature of said diffuse reflecting material below a softening point.

27. The apparatus of claim 25, wherein the shaped surface is a microwave lamp reflector forming part of a microwave cavity used to couple microwaves into an electrodeless lamp.

28. The apparatus of claim 25, wherein the shaped surface is an elliptical reflector.

29. The apparatus of claim 25, wherein the shaped surface is a parabolic reflector.

30. A method of curing a substance comprising exposing said substance to ultraviolet (UV) light, wherein at least some of said UV light is reflected off a diffuse reflector prior to contacting said substance.

31. The method of claim 20, further comprising cooling said diffuse reflector, wherein a temperature of a diffuse reflecting material on said diffuse reflector does not exceed a maximum operating temperature.
